(19) United States
(12) Patent Application Publication
(10) Pub. No.: US 2005/0286480 A1
(43) Pub. Date: Dec. 29, 2005

(54) Radio apparatus joining an IBSS or ad hoc network

(75) Inventor: Hiroyuki Akiyama, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/157,811

(22) Filed: Jun. 22, 2005

(30) Foreign Application Priority Data
Jun. 24, 2004 (JP) 2004-186601

(51) Int. Cl. H04Q 7/24

(52) U.S. Cl. 370/338; 370/331

(57) ABSTRACT

A radio apparatus applicable to an IBSS (Independent Basic Service Set) network includes a timing generator for generating a timing signal in accordance with the phase of a received frame. A decision circuitry acquires the source address of the received frame in response to the timing signal and received frame, and determines the type of the received frame and whether or not the received frame is addressed to the radio apparatus and correctly received. A registrar acquires information representative of the processing capability of a source from the received frame in accordance with the timing signal, signals output from the decision circuitry and source address and registers the above information and source address. A canceller determines withdrawal from an IBSS area in response to the timing signal, signals output from said decision circuitry, source address and particular information relating to the type of the received frame.

### BACKGROUND OF THE INVENTION

1. Field of the Invention

The present invention relates to a radio apparatus and more particularly to a radio apparatus capable of registering a mobile station joining an ad hoc network and canceling the registration.

2. Description of the Background Art

IEEE (Institute of Electrical and Electronics Engineers) provides specifications for connecting, e.g. radio apparatuses fixed in a local area and cellular phones or similar mobile radio apparatuses by using radio media in Wireless LAN Medium Access Control (MAC) and Physical Layer (PHY) Specifications, ANSI/IEEE Std. 802.11, Ed. 1999. LANs (Local Area Networks) connected by radio are generally referred to as wireless LANs. Particularly, standards that use radio media belonging to a 5 GHz and a 2.4 GHz band are classified in IEEE 802.11a, 802.11b and 802.11g. Generally, two different kinds of areas, i.e. BSS (Basic Service Set) areas and IBSS (Independent Basic Service Set) areas are available with wireless LANs.

The BSS proceeds in such a fashion that, when a radio apparatus, referred to as a base station apparatus, serving as an access point (AP), is started up, it authenticates a mobile station or apparatus desiring to join the service area of the access point to thereby register the mobile apparatus, and then executes a procedure called association for designating an access point. Let the base station and mobile apparatuses be simply referred to as an access point (AP) and a station (STA), respectively, hereinafter. A BSS area is characterized by its connectability to a data distribution system referred to as a distribution system (DS). A distribution system connects access points included in some different BSS areas for thereby allowing data to be transferred between the BSS areas. In addition, a distribution system is connectable even to a wired LAN based on IEEE 802.3 or similar standard when provided with a bridge point called a portal.

Another characteristic configuration of a BSS procedure is that the access point handles a beacon frame, i.e. periodically sends a beacon for reporting the presence of an 802.11 network. A beacon frame has a format including a time stamp, a beacon interval, a service set identity (SSID), robust security network (RSN) information, supported rates, extended supported rates and so forth. The time stamp is information used to synchronize counters included in the individual stations and each having a timing synchronization function (TSF) within the area. The beacon interval shows an interval between consecutive beacon frames to be sent. The SSID is representative of the identification (ID) of the service set while the RSN information is representative of the security capability of the area. Further, the supported rate and extended supported rates both show supported rates that the access point can support.

By broadcasting beacon frames having the above format, the access point requests all stations to send out information stored therein while advertising them. Further, by periodically sending beacon frames, the access point transfers area information to all stations at all times.

The IBSS differs from the BSS stated above in that it is dealt with by a system not including a radio apparatus for controlling the area like the access point. IBSS refers to a network to be started up by a station instead of by an access point and using only stations. IBSS, as distinguished from BSS, is not connectable to a distribution system and, in this sense, independent. It follows that an IBSS area does not include a bridge point or portal and is therefore not connectable to a wired LAN based on, e.g. IEEE 802.3. In an IBSS area that does not include an access point, all stations joining the area send beacon frames alternately with each other. A beacon frame dealt with by IBSS stores substantially the same information as the beacon frame dealt with by BSS and is sent out for the same purpose as in BSS. Typical of IBSS is an ad hoc network different from an access point or similar fixed network.

The operation of BSS will be described hereinafter. An access point starts up services in a BSS area and then starts sending a beacon frame to the area. At this instant, the beacon frame indicates time uniformed in the area as a time stamp and requests and advertises a processing capacity, or capability, required of stations to join the area, as stated earlier. A station, desiring to join a BSS area, probes neighborhood thereof for a desired BSS area either by waiting for a beacon to be sent from an access point or by positively sending a probe request frame and waiting for a probe response frame from an access point. The station, even when having selected the transmission of a probe request frame, is capable of obtaining information necessary for joining the area in the same manner as when having received the beacon frame because the probe response frame stores information similar to information stored in the beacon frame.

On receiving the beacon or probe response frame from an access point, the station determines, based on the frame information, whether or not the area is adaptive to the station's desired conditions and whether or not the station itself is adaptive to the condition particular to the area, and then decides whether or not to join the area.

Upon determining to join the area, the station sends out an authentication request frame to the access point that controls the area. In response, the access point determines whether or not to authenticate the station having sent the authentication request frame and then returns an authentication answer frame storing the result of the above decision to the station. If the station is not authenticated by the access point, the station gives up joining the area and simply withdraws from the area. If the station is authenticated by the access point, the station sends out to the access point an association request frame storing a processing capability available with the station. On receiving the association request frame, the access point determines whether or not the processing capability of the station is high enough to deal with the area. Thus, the station determines the adaptability of processing capability at the time of authentication while the access point determines the processing capability of the station at the time of association.

If the processing capability of the station is acceptable, the access point registers the station as a mobile station present in the control area, stores the address and processing capability data of the station, and sends out an association response frame representative of the successful association to the station. As soon as the station receives the association response frame, it is allowed to start transmitting and receiving data frames to and from the access point. If the association response frame is representative of the failure of association, the station withdraws from the area.

An IBSS area is started up by a station. The station having started up the area then starts sending a beacon frame. This beacon frame stores substantially the same information as the beacon frame of BSS although part of the information is particular to IBSS. While BBS causes an access point to periodically send a beacon frame alone, as stated previously, IBSS causes all stations joining the area to send beacon frames alternately with each other. More specifically, at the time when the IBSS area is started up, only the station having started up the IBSS area joins the area and therefore sends a beacon frame at beacon intervals alone. Subsequently, when another station joins the same IBSS area, the two stations send beacon frames alternately with each other by using random time management.

As for the alternation, each station determines a randomly selected waiting time at a beacon transmission timing determined by the station, so that only the station whose waiting time has elapsed or expired sends a beacon frame. More specifically, by using a random waiting time, the station whose waiting time has elapsed first sends a beacon frame while the other station, not sending a beacon frame, cancels the waiting time in response to a beacon frame received before the elapse of the waiting time for thereby canceling the transmission of a beacon frame. In this manner, all stations, desiring to join the area, are caused to send beacon frames alternately with each other, i.e. prevented from sending out beacon frames at the same time as each other.

A station, desiring to join IBSS, waits for the receipt of a beacon frame or positively sends out a probe request frame in order to search for a desired area neighboring it in the same manner as in BSS. A station that responds to the probe request frame in IBSS is one that has sent out a beacon frame immediately before. Thus, all stations present in the IBSS area send beacon frames alternately with each other.

It should be noted that all beacon frames to be sent from stations present in the IBSS area contain identical information, and so do all probe response frames. Should the content of a beacon frame differ from one station to another, a station would occasionally fail to join in IBSS as a result of a decision based on a received content. A station desiring to join IBSS, like a station desiring to join BSS, should preferably be able not only to determine the adaptability of its own processing capability, but also to store the content of a beacon frame so as to send beacon frames storing identical information after joining IBSS.

Now, a station having joined IBSS does not have to send an authentication frame to the other stations present in the area. In other words, authentication in IBSS is optional. If a station sends an authentication request frame, a station to which the frame is addressed makes a decision on authentication, stores the result of the decision in an authentication answer frame and then returns the answer frame to the source station. Further, association is not executed in IBSS, as provided by IEEE 802.11, so that a station having joined IBSS does not send an association request frame. It follows that a station, desiring to join IBSS, does not more than determine whether or not its own processing capability matches the area on the basis of a beacon or probe response frame, while stations having already joined IBSS are unable to confirm the capacity of the above station. Stated another way, the stations having already joined IBSS are allowed to start sending and receiving data frames without any authentication or association.

Considering communications through radio media, IEEE 802.11 provides a radio apparatus with a function of resending data when communication conditions are unstable in BSS or IBSS stated above. More specifically, upon receiving a transmission frame, an access point or a station confirms the normalcy of data with a CRC (Cyclic Redundancy Check) scheme and then returns an ACK (ACKnowledgement) frame in order to inform a good or normal receipt of the transmission frame. The ACK frame accords to the format of an MAC frame provided by IEEE 802.11 and is output in a short interframe space (SIFS) after the transmission of a data frame from a source station. The ACK frame is returned only if the result from the CRC checking is correct. This allows the access point or the station, which is a source, to see if the data frame it sent has been successfully received by the destination. If the answer of this decision is negative, the source can again send out the same frame to the destination.

When a station brought into association with BSS withdraws a BSS area, the station sends a deauthentication or disassociation frame to the access point. In response, the access point recognizes the withdrawal of the station from BSS and cancels the registration of the station. Alternatively, the access point may report withdrawal from BSS to the station. More specifically, when a station that should withdraw exists, the access point may send a deauthentication or disassociation frame to the station and then cancel the registration of the station.

When a station, joining an IBSS area, withdraws the IBSS area, the station is capable of sending a deauthentication frame to the other stations present in the area to thereby inform them of the withdrawal. Alternatively, in IBSS in which authentication is optional, the station may withdraw the area without sending the deauthentication frame. In IBSS, a station does not execute the association procedure and is therefore unable to send a disassociation frame.

To better understand the background of the present invention, a wireless LAN communication method taught in Japanese patent laid-open publication No. 2004-72565, for example, will be described hereinafter. In accordance with the method taught in this document, a plurality of wireless terminals are connected to a network which is controlled by an access point.

When one of the above wireless terminals receives network information including a network name and sent from the access point, the wireless terminal compares the network name and the name of a network to which it belongs. If the two network names are identical, the wireless terminal sends at least the network name and address information relating to the network. On receiving a network name and address information relating thereto from another wireless terminal, the wireless terminal generates an address table in accordance with the network name and address information, references the address table to see if any other wireless terminal exists in an area that allows radio communication to be directly held, and directly holds, if another wireless terminal exists, radio communication with such a wireless terminal under the control of the access point.

The wireless LAN communication system is thus adapted to allow radio communication terminals capable of, even when connected to a network controlled by an access point, establishing a direct radio transmission over an ad hoc network to execute a direct radio transmission with each other in the ad hoc mode. Traffic load on the entire network is therefore reduced, and radio terminals involved in the direct radio transmission in the ad hoc mode may collectively be controlled by a network managed by an access point.

On the other hand, Japanese patent laid-open publication No. 2004-23721, for example, discloses an ad hoc mode switching method that allows a person to switch the ad hoc mode of a wireless LAN by hand in accordance with, e.g. whether or not a beacon is present, thereby automatically establishing an adequate mode while obviating troublesome processing to be executed before operation. More specifically, the ad hoc mode switching method sets, at the time of initial setting, an ad hoc mode with beacon in the wireless LAN of terminals to be provided with services, determines whether or not a communication from an ad hoc network with beacon occurs within a predetermined period of time, and automatically replaces, if the answer of this decision is negative, the ad hoc mode with beacon with an ad hoc mode without beacon.

In a conventional wireless LAN area provided by, e.g. IEEE 802.11a, all stations joining the area are allowed to communicate with each other by an orthogonal frequency division multiplex (OFDM) system lying in a 5 GHz band while encryption is adaptive only to wired equivalent privacy (WEP). On the other hand, in a radio area provided by IEEE 802.11b, communications are implemented only by a direct sequence spectrum spread (DSSS) system lying in a 2.4 GHz band and a complementary code keying (CCK) system while encryption is implemented only by WEP key. It follows that stations to join in either one of such radio areas are capable of encrypting data frames and transmitting and receiving encrypted data frames only if they are informed of a processing method uniformed in the area.

However, IEEE 802.11g recently established as a new standard recommendation and IEEE 802.1 μl to be established in the near future both include specifications for varying a modulation/demodulation system and an encryption system for data transmission in accordance with the processing capability of the individual station joining an area, as shown and described in “Further Higher Data Rate Extension in the 2.4 GHz Band”, IEEE Std. 802.11g, 12 Jun. 2003 and “Medium Access Control (MAC) Security Enhancement”, IEEE P802.1 μl, Draft 10.0, respectively. More specifically, IEEE 802.11g allows a plurality of modulation/demodulation systems including e.g. OFDM, DSSS and CCK to be selectively used in the same area. Likewise, IEEE 802.1 μl allows WEP, temporal key integrity protocol (TKIP), counter mode with cipher-block chaining MAC protocol (CCMP) and other modulation/demodulation systems to be selectively used in the same area. It is therefore likely that a processing capability is different between stations belonging to the same area.

In accordance with IEEE 802.11g, a destination station may have an OFDM receipt capability in addition to a DSSS receipt capability while, in accordance with IEEE 802.1 μl, a destination station may have only a TKIP decoding capability or both of a TKIP and a CCMP decoding capability. In a wireless LAN area implementing such a new standard, it is possible to grasp and register or store the processing capability of an individual station joining the area to implement optimum data transfer between the stations. Under the circumstances, stations, joining a wireless LAN area based on IEEE 802.11, each should preferably be capable of grasping and registering or storing the processing capabilities of the other stations so as to match its own processing capability to that of the station to communicate with. In the case of BSS, an access point is capable of grasping and registering or storing the processing capability of a destination station in accordance with an association request frame sent from a source station to newly join the area.

However, as for an IBSS or ad hoc network, stations, joining the same area, each are unable to see the processing capabilities of the other stations and therefore to grasp and register or store them because a station to newly join the area does not execute association processing. Further, when one of the stations, joining the area, withdraws from the area, the other stations are unable to see the withdrawal and therefore to cancel the registration because IBSS allows a station to withdraw from an area without sending an authentication cancellation frame. In fact, it is known that many of products available on the market are not configured to send out an authentication cancellation frame when withdrawing from an area.

### SUMMARY OF THE INVENTION

It is an object of the present invention to provide a radio apparatus capable of registering stations joining an IBSS or ad hoc network and canceling the registration.

A radio apparatus applicable to an IBSS network of the present invention is implemented as a mobile station. The radio apparatus includes a timing generator for generating a timing signal in accordance with the phase of a received frame. A decision circuitry acquires the source address of the received frame in accordance with the timing signal and received frame, and determines the type of the received frame and whether or not the received frame is addressed to the radio apparatus and correctly received. A registrar acquires information representative of the processing capability of a source from the received frame in accordance with the timing signal, signals output from the decision circuitry and source address, and registers the above information and source address. A canceller determines withdrawal from an IBSS area in accordance with the timing signal, signals output from the decision circuitry, source address and particular information relating to the type of the received frame.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of the radio apparatus in accordance with the present invention;

FIG. 2 is a schematic block diagram showing a specific configuration of a registrar included in the illustrative embodiment;

FIG. 3 is a schematic block diagram showing a specific configuration of a canceller also included in the illustrative embodiment;

FIG. 4 is a timing chart useful for understanding a specific registration procedure executed by the illustrative embodiment;

FIGS. 5 and 6 show a table indicative of a relation between the kind of an MAC frame included in a received frame, a type and a subtype;

FIG. 7 is a timing chart, like FIG. 4, useful for understanding a specific cancellation procedure executed by he illustrative embodiment;

FIG. 8 is a timing chart useful for understanding the transmission of beacon frames in IBSS; and

FIG. 9 is a timing chart useful for understanding the transmission of beacon frames in IBSS together with the operation of a beacon receipt management table.

### DESCRIPTION OF THE PREFERRED EMBODIMENT

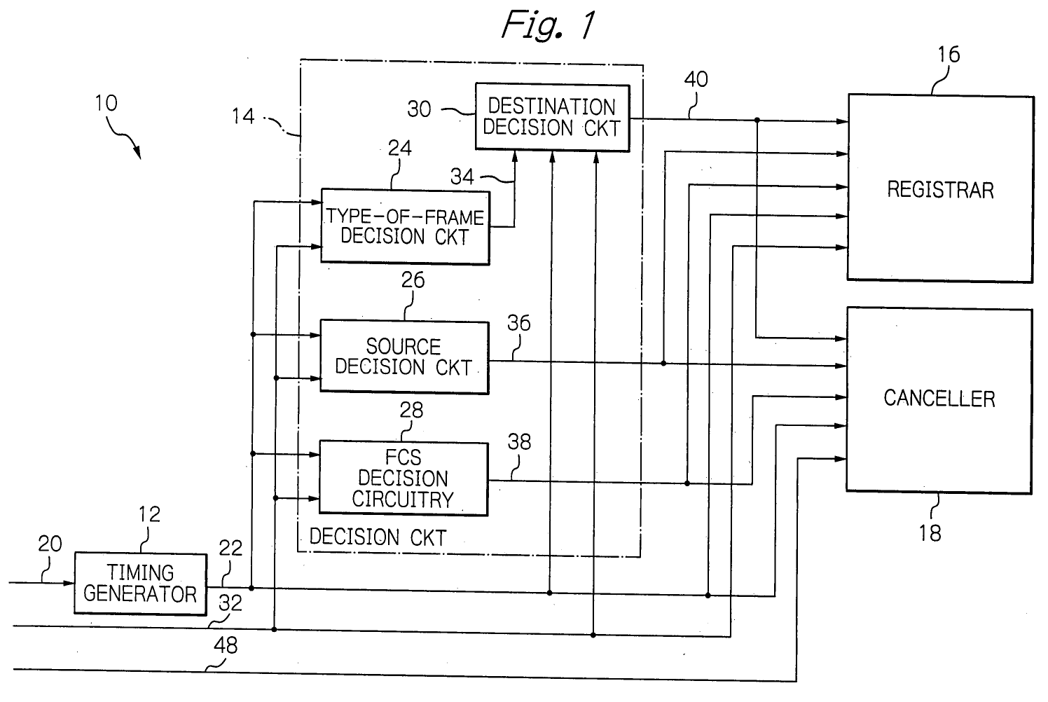

Referring to FIG. 1 of the accompanying drawings, a radio apparatus embodying the present invention is implemented as a station 10 for a mobile radio station by way of example. Let the mobile radio station 10 for a mobile station be simply referred to as a station 10 hereinafter. It is to be noted that parts and elements included in the station 10, but not directly relevant to the understanding of the present invention, are not shown or will not be described.

As shown in FIG. 1, the station 10 is generally made up of a timing generator 12, decision circuitry 14, a registrar 16 and a canceller 18, which are interconnected as illustrated. The timing generator 12 is adapted to, supplied with a received frame phase 20, generate a timing signal 22 matching with a received frame and delivers the timing signal 22 to the decision circuitry 14, registrar 16 and canceller 18. Signals appearing in the station 10 are thus designated by reference numerals attached to connect lines on which they appear.

The decision circuitry 14 comprises a type-of-frame decision circuit 24, a source decision circuit 26, a frame check sequence (FCS) decision circuit 28 and a destination decision circuit 30, which are interconnected as shown. The type-of-frame decision circuit 24, source decision circuit 26, FCS decision circuit 28 and destination decision circuit 30 are respectively adapted to determine the type of a received frame, a source address, an FCS and a destination address. More specifically, the type-of-frame decision circuit 24 separates an MAC header from a received frame 32 in response to the timing signal 22 and analyzes the MAC header thus separated to see if the received frame 22 is a beacon frame or not. The type-of-frame decision circuit 24 then feeds a decision signal 34 representative of the result of the decision to the destination decision circuit 30.

The destination decision circuit 26 separates the MAC header contained in the received frame 32 in response to the timing signal 22, analyzes the MAC header thus separated to acquire a destination address, and then delivers the destination address to the registrar 16 and canceller 18.

The FCS decision circuit 28 is adapted for determining, responsively to the timing of the timing signal 22, whether or not the received frame 32 is normal. More specifically, the FCS decision circuit 28 executes a frame check sequence, which is a CRC checking with the illustrative embodiment, in which a CRC-32 operation provided by IEEE 802.11 is performed on all fields included in the MAC header and the frame body. The FCS decision circuit 28 analyzes the content of the MCA header separated, compares an FCS bit added to the tail of the frame with a result of the operation, determines, based on the result of comparison, whether or not the received frame 32 is normal, and then sends out a normalcy decision signal 38 representative of the result of the decision to the registrar 16 and canceller 18.

The destination decision circuit 30 analyzes the received frame 32 on the basis of the MAC header of the received frame 32 and frame decision signal 34 at the timing defined by the timing signal 22, thereby determining whether or not the received frame 32 is addressed to the station 10. The answer of this decision is positive if the received frame 32 is a beacon frame and if the beacon frame is addressed to a broadcast address particular to an area that the station 10 joins. The destination decision circuit 30 feeds a decision signal 40 representative of the result of the above decision on the broadcast address to the registrar 16 and canceller 18.

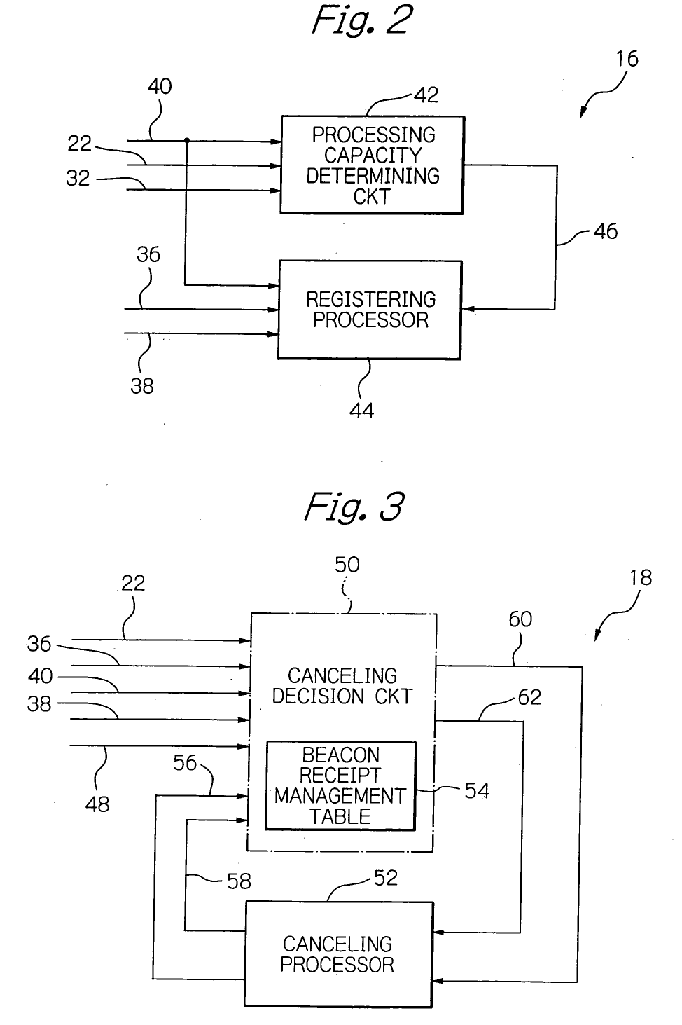

The registrar 16 analyzes the received frame 22 in accordance with the information input thereto and registers the address of a station having sent the frame 22 as a new station together with information representative of a processing capability available with the new station. As shown in FIG. 2 specifically, the registrar 16 includes a processing capability determining circuit 42 and a registering circuit 44, which are interconnected as depicted. The processing capability determining circuit 42 is adapted to analyze the frame body of the received frame 32 in response to the timing signal 22, received frame 32 and decision signal 40 input thereto to thereby determine the processing capability of a station having sent the beacon frame. The processing capability detector 42 then feeds information 46 representative of the processing capability thus determined to the registering processor 44.

The registering processor 44 is adapted to register an address and processing capability information relating to a new station in accordance with the source address 36, decision signal 40, normalcy decision signal 38 and processing capability information 46. More specifically, the registering processor 44 references the decision signal 40 to determine whether or not the received frame 32 is addressed to the station 10, accepts, if the answer of the decision is positive, the source address 36 as the address of a station to register, and then determines whether or not the source address 36 has been received from a station currently unregistered. If the answer of this decision is positive, the registering processor 44 analyzes the station on the basis of the source address 36, normalcy decision signal 38 and processing capability information 46 and then registers the address and processing capability information 46 particular to the unregistered station. The registering processor 44 includes a device for registration, e.g. a memory or a D-type of flip-flop, although not shown specifically.

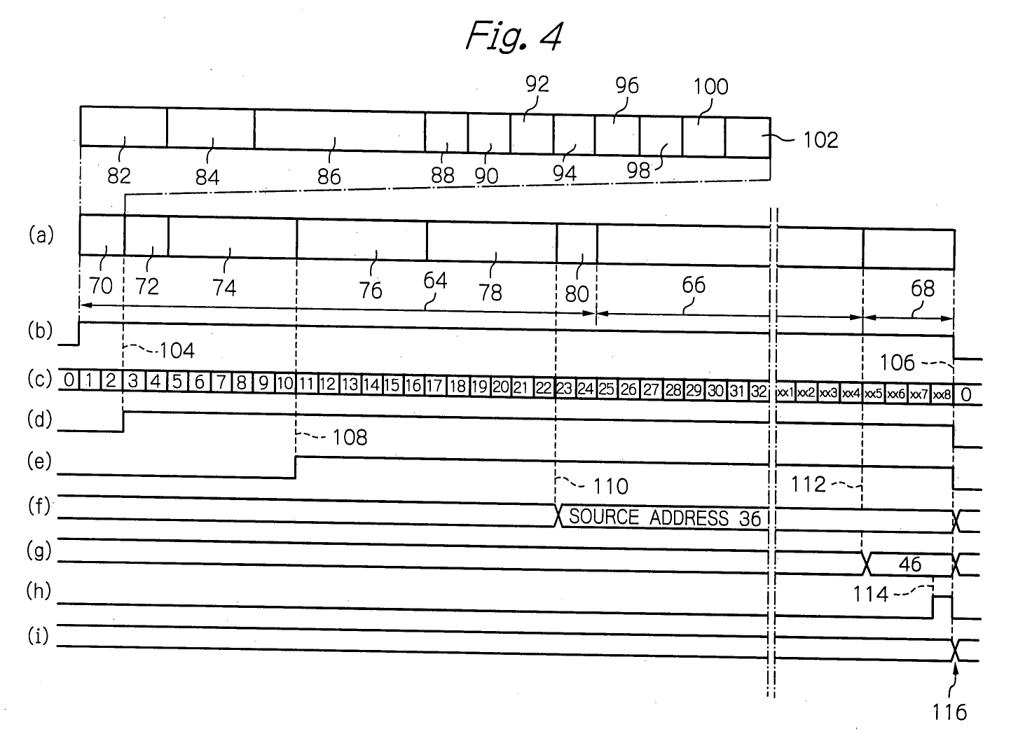

Referring again to FIG. 1, own-station beacon transmission information 48 is input to the canceller 18 in addition to the timing signal 22, source address 36, decision signal 40 and normalcy decision signal 38. FIG. 3 shows a specific configuration of the canceller 18. As shown, the canceller 18 includes a canceling decision circuit 50 and a canceling processor 52, which are interconnected as illustrated. The addresses 56 of stations currently registered and information 58 representative of the number of such stations are input from the canceling processor 52 to the canceling decision circuit 50.

The canceling decision circuit 50 includes a beacon receipt management table 54, which may be implemented by a buffer memory by way of example. The beacon receipt management table 54 lists cumulative values in one-to-one correspondence to a plurality of stations. Receiving the decision signal 40 at the timing defined by the timing signal 22, the canceling decision circuit 50 determines whether or not the received frame 32 addressed to the station 10 is a beacon frame and whether or not the beacon frame is meant for the station 10. If the answers of such decisions both are positive, the canceling decision circuit 50 references the normalcy decision signal 38 to see if the received frame 32 is normal. If the received frame 32 is normal, the cancellation deciding circuit 50 compares the source address 36 with station addresses 56 currently under control to determine whether or not the source station having sent the beacon frame is currently under control. The canceling decision circuit 50 then increments or decrements, based on the result of the above decision and the own-station beacon transmission information 48, the cumulative value of the station concerned and stored in the beacon receipt management table 54, as will be described later more specifically.

Further, the beacon receipt management table 54 functions to determine whether or not the source station having sent the beacon frame has withdrawn from the area on the basis of whether or not the cumulative value of the source station has reached a predetermined threshold value. In the illustrative embodiment, the threshold value is selected to be an N multiple (N being an integer greater than 1) of the information 58 representative of the number of stations present in the area, as will be described later more specifically. The canceling decision circuit 50 with such functions delivers a cancellation command signal 60 and a cancellation address 62 to the canceling processor 52.

The canceling processor 52 is adapted to analyze the cancellation command signal 60 and cancellation address 62 fed from the canceling decision circuit 50 to thereby cancel the address and processing capability of the registered station. The canceling processor 52, like the registering processor 44, includes a memory, a D-type of flip-flop or similar storing device. Preferably, therefore, the canceling processor 52 and registering processor 44 should share such a storing device with each other. Further, the canceling processor 52 outputs the addresses 56 of registered stations and information 58 representative of the number of registered stations.

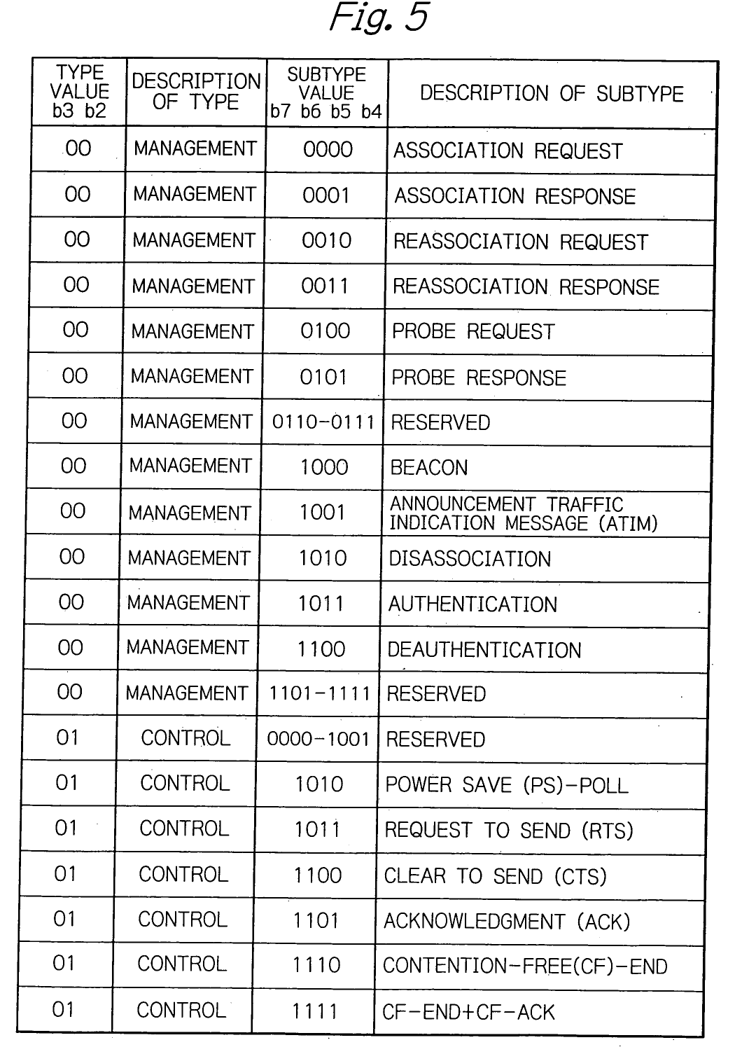

A specific registration procedure included in the operation of the station 10 will be described hereinafter. FIG. 4, line (a), shows the received frame 32 made up of various fields arranged in a beacon frame format. As shown, the beacon frame consists of a twenty-four-octet MAC header field 64, a variable-length-octet frame body field 66 and a four-octet FCS field 68. The MAC header field 64 includes a frame control (FC) field 70, a duration (D) field 72, a destination address (DA) field 74, a source address (SA) field 76, a BSS identification (BSSID) field 78 and a sequence control (SC) field 80.

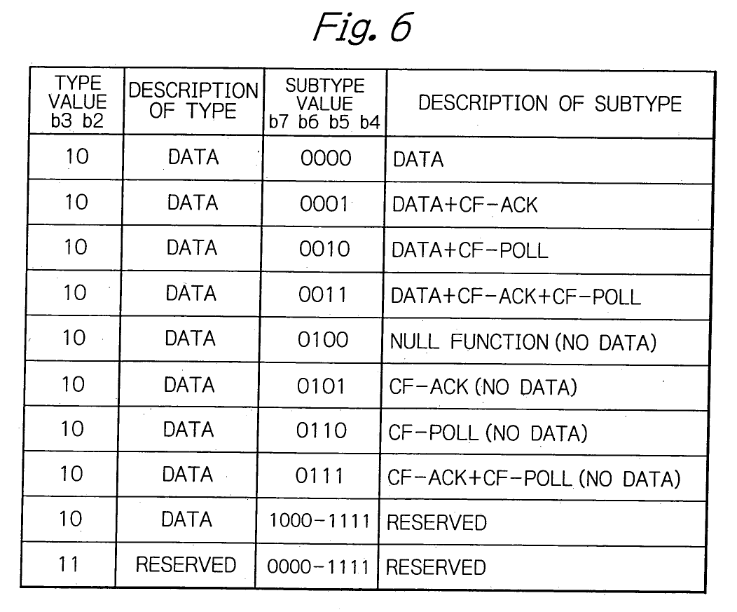

Further, the frame control field 70 is subdivided into a plurality of subfields, i.e. a protocol version subfield 82, a two-bit type subfield 84 representative of a general type, a four-bit subtype subfield representative of a detailed type, a ToDS bit subfield 88, a FromDS bit subfield 90, amore fragment bit subfield 92, a reset bit subfield 94, a power control bit subfield 96, a more data bit subfield 98, a WEP bit subfield 100 and a sequence bit subfield 102. FIGS. 5 and 6 show tables listing a relation between the type of an MAC frame, a type and a subtype.

FIG. 4, line (b), shows the received frame phase 20. FIG. 4, line (c), shows the timing signal 22 delivered from the timing generator 12 to the type-of-frame decision circuit 24, source decision circuit 26, FCS decision circuit 28, destination decision circuit 30, registrar 16 and canceller 18. Particularly, the type-of-frame decision circuit 24, source decision circuit 26, FCS decision circuit 28 and destination decision circuit 30, included in the decision circuitry 14, each are capable of determining and recognizing the phase of the associated field of the received frame 32 in response to the timing signal 22 to thereby acquire desired information.

FIG. 4, line (d), shows the result of the decision made by the type-of-frame decision circuit 24 as to whether the received frame 32 is a beacon frame or not. As shown in FIG. 5, if the type subfield and subtype subfield of the frame control field 70 are “00” and “1000”, respectively, the type-of-frame decision circuit 24 determines that the received frame 32 is a beacon frame. As shown in FIG. 4, line (d), the frame decision signal 34, output from the type-of-frame decision circuit 24, goes high at a time 104 coincident with the end of the frame control field 70 and then goes low at a time 106 coincident with the end of the received frame 32.

FIG. 4, line (e), shows the decision signal 40 output from the destination decision circuit 30 and showing whether or not the received frame 32 is addressed to the station 10, FIG. 1. As shown, if the received frame 32 is a beacon frame and if the beacon frame is addressed to the station 10, the decision signal 40 goes high at a time 108 coincident with the end of the destination address field 74 and then goes low at the time 106 coincident with the end of the received frame 32. This decision can be done because if the received frame 32 is a beacon frame, the destination address field 74 is a broadcast address that is entirely in a high level.

FIG. 4, line (f), shows the source address 36. The source decision circuit 26 determines, based on the BSSID field 78 of the received frame 32 indicative of an IBSS area, whether or not the received frame 32 is sent from a station joining the IBSS area. If the answer of this decision is positive, the source decision circuit 26 detects a source address out of the source address field 76 just preceding the BSSID field 78 and then causes the source address 36 to go high at a time 110 coincident with the end of the BSSID field 78 and remain high up to the time 106 coincident with the end of the received frame 32.

FIG. 4, line (g), shows the processing capability information 46 output from the processing capability detector 42 at the end of the frame body field 66. If the decision signal 40 output from the destination decision circuit 30 is in a high level, meaning that the received frame 32 is a beacon frame addressed to the station 10, the processing capability detector 42 detects and determines information stored in the frame body field 66 and then outputs the information 46 representative of the processing capability of the source station at a time 112, which is coincident with the end of the frame body field 66.

More specifically, the processing capability detector 42 obtains a Robust Security Network (RSN) information element, Extended Rate PHY (ERP) information and Extended Supported Rates (ESR) stored in the frame body field 66 as the processing capability information 46. The RSN information element is representative of a processing capability available with the security of a station that sends a beacon frame as provided by IEEE 802.1 μl. If an RSN information element field is absent in the frame body of the received frame 32, the processing capability detector 42 determines that the station having sent the received frame 32 practically lacks the above processing capability.

The ERP information and ESR are representative of an extended processing capability available with a station, which sends out a beacon, at a high data rate provided by IEEE 802.11g. If such fields are absent in the frame body of the received frame 32, the processing capability determining circuit 42 determines that the above station is practically unable to use an orthogonal frequency division multiplexing (OFDM) modulation and demodulation system also provided by IEEE 802.11g.

In summary, the processing capability information 46 includes information relating to a coding system representative of a security processing capability provided by IEEE 802.1 μl and a modulating/demodulating system representative of a high data rate, extended processing capability provided by IEEE 802.1g. If an RSN information field, an ERP information field and an extended supported rates field are absent, the processing capability information 46 shows that a coding system and a modulating/demodulating system are not available at all. More specifically, the absence of a coding system means that a station is adaptive to conventional WEP, but lacks a TKIP (Temporal Key Integrity Protocol)/CCMP (Counter-Mode/CBC-MAC Protocol) processing capability. Also, the absence of a modulating/demodulating system means that a station is adaptive to DSSS/CCK, but lacks an OFDM processing capability.

FIG. 4, line (h), shows the normalcy or FCS decision signal 38. The FCS decision circuit 28 calculates CRC-32 with the received frame 32 and compares the calculated CRC-32 with an FCS value stored in the last field of the received frame 32. The FCS decision circuit 28 causes the normalcy decision signal 38 to go high if the calculated CRC-32 and FCS value compare equal at a time 114 lying in the end portion of the FCS field 68 of the received frame 32, but maintains the signal 38 in a low level if otherwise.

As shown in FIG. 4, line (i), the registering processor 44 registers the processing capability information 46 and source address 36 after a time 116. More specifically, the registering processor 44 determines whether or not the decision signal 40 is in a high level, whether or not the source address 36 does not coincide with any one of registered addresses and whether or not the normalcy decision signal 38 is in a high level. If the results of such decisions are positive, the registering processor 44 registers the address and processing capability of the other station present in the IBSS area in together with the station 10. The registering processor 44 does not register them if any one of the answers of the above decisions is negative.

More specifically, a station, lacking a Robust Security Network Association (RSNA) ability, which is expected to be standardized by IEEE 802.1 μl, is capable of switching, on an area basis, the kind of a code for a broadcast frame on the basis of information indicative of “newly registered”. Also, a station lacking an ERP ability standardized by IEEE 802.11g, is capable of switching, on an area basis, a protection function from OFF to ON in accordance with registered information. Stated another way, processing capability information acquired on a station basis is not only used for processing using a station as a unit, but is also applicable to processing using a wireless LAN area as a unit. The processing capability information can be managed and controlled on the basis of the processing capability of a station newly registered any time.

The illustrative embodiment detects and registers the processing capability of a source station in accordance with a beacon frame received, as stated above. Alternatively, the processing capability of a source station may be detected and registered on the receipt of a probe response frame to which station processing capability is added in the same manner as it is added to a beacon frame. Further, the operation of the registering processor 44 has been described on the assumption of a specific case wherein the received source address 36 does not compare equal with any one of registered station addresses. However, even in a case wherein the received source address 36 is identical with some registered station address, the registering processor 44 is able to replace, in the event when the processing capability information of a registered station is varied, the registered processing capability with new processing capability information 46.

In the illustrative embodiment, on receiving a probe response frame which is a specific form of a beacon frame, the processing capability detector 42 determines the processing capability of a source station on the basis of the presence/absence of an RSN information element field, an ERP information field and an extended supported rates field. Alternatively, the processing capability determining circuit 42 may analyze more detailed information indicated by the RSN information field to thereby register detailed security information of a station having sent a frame, if desired. The security information includes some different code types and authenticating methods.

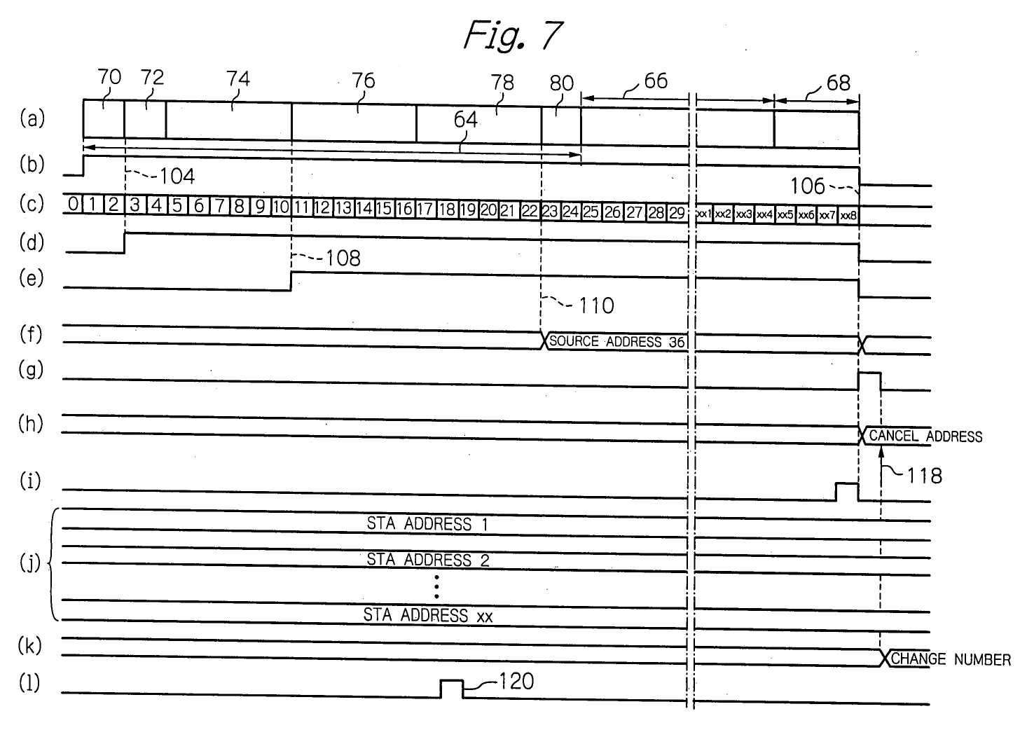

Reference will now be made to FIG. 7 for describing a specific cancellation procedure also included in the operation of the station 10, FIG. 1. FIG. 7, lines (a) through (f) and (i), respectively correspond to FIG. 4, lines (a) through (f) and (h) showing the fields of a beacon frame format, received frame phase 20, timing signal 22, frame decision signal 34, address decision signal 40, source address 36 and normalcy decision signal 38, and will not be described specifically in order to avoid redundancy.

FIG. 7, line (g), shows the cancellation command signal 60 generated by the canceling decision circuit 50 on the basis of the timing signal 22, source address 36, normalcy decision signal 38, decision signal 40, beacon transmission information 48, address information 56 and number information 58 when the following conditions are satisfied. The first condition is that the cancellation deciding circuit 50, operated in response to the timing signal 22, determines that the received frame 32 is normal in response to the normalcy decision signal 38 and that the received frame 32 is addressed to the station 10 in response to the decision signal 40.

The second condition is that the canceling decision circuit 50 determines whether or not the source address 36 is identical with any one of the addresses stored in the beacon receipt management table 54, selectively increments or decrements a value stored in the table 54 in accordance with the identical address and beacon transmission information 48, and then determines whether or not the resulting value is equal to an N multiple of the number-of-station information 58. If the answer of this decision is positive, the canceling decision circuit 50 determines that a station to which the above value is attached has been brought out of the area, and then outputs the cancellation command signal 60 and the address 62 of the above station to be deleted to the canceling processor 52. In response, the canceling processor 52 causes the cancellation command signal 60 and address 62 to go high at the time 106 and then go low at a time 118, see FIG. 7, line (h), after the end of the received frame 32.

FIG. 7, line (j), shows how the addresses of stations, stored in a memory, a D-type of flip-flop or similar storing device, are managed. The canceling circuit 52 cancels the address 62 of the station designated by the cancellation command signal 60. Further, as shown in FIG. 7, line (k), the canceling processor 52 varies the number-of-station information 58 representative of the number of registered stations after the time 118 and feeds the resulting number information 58 to the canceling decision circuit 50.

FIG. 7, line (1), shows the own-station beacon transmission information 48 indicating that the station 10 itself has sent a beacon frame. At a timing 120 shown in FIG. 7, line (1), the values of all stations listed in the beam receipt management table 54 are incremented by “1” (one), and then cancellation is effected. Although the own-station beacon transmission information 48 occurs asynchronously to the received frame 32, a wireless LAN uses a half-duplex communication system in which transmission and receipt do not occur at the same time. In this sense, FIG. 7, line (1), indicates that cancellation by the canceller 18 and cancellation of the beacon transmission information do not occur at the same time.

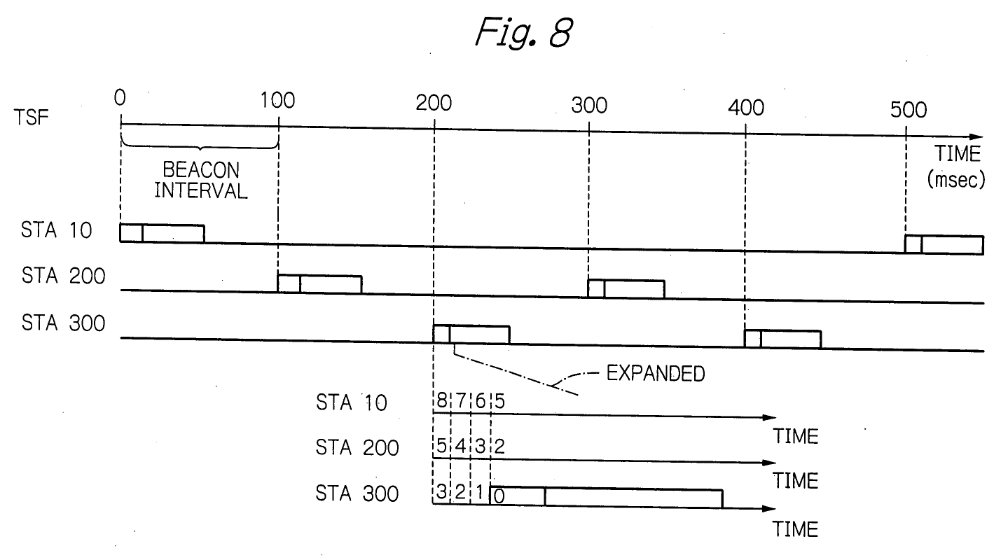

Why the fist and second conditions stated in relation to the decision on cancellation hold will be described hereinafter. FIG. 8 shows a specific case wherein the own station 10 and other stations 200 and 300 join an IBSS area together. A beacon transmission timing based on the timing synchronization function (TSF) is shown at the top of FIG. 8. The TSF function, uniformed in the area, basically manages time with a simple, incrementing counter having its full count of sixty-four bits, a count being stored in a beacon frame as a time stamp. The incrementing counter is adapted to start counting time from 0 millisecond at which the area is stated up on a millisecond basis, allowing beacon frames sent at preselected intervals to be recognized. Why such a function is referred to as TSF function is partly that the beacon frame transmission timing is synchronous with the simple incrementing counter.

The time when the first beacon frame is to be transmitted is determined to be coincident with the time 0 of the simple incrementing counter beforehand. Stated another way, a station, having started up the IBSS area, sends the first beacon frame at the time 0. In the specific condition shown in FIG. 8, the station 10 is assumed to have started up the IFSS area first and therefore sends out or transmits a beacon frame at the time 0.

Intervals at which beacon frames are sent will be described hereinafter. The intervals to be described are uniformed in the IBSS area and stored in beacon frames as beacon interval information. In FIG. 8, three stations, i.e. the own station 10 and two other stations 200 and 300 are shown as sequentially sending beacon frames at the intervals of 100 milliseconds from the time 0 of the TSF function.

At the bottom of FIG. 8, it is shown how the TSF function, i.e. the simple incrementing counter, transmits a beacon frame from the station 200 in 200 milliseconds, as counted from the time 0. As for an IBSS area, all stations joining the area send beacon frames alternately with each other by using random values. FIG. 8 demonstrates a specific condition wherein the random values of the stations 10, 200 and 300 are respectively “8”, “5” and “3” in 200 milliseconds and are sequentially decremented later, the station 300 having reached “0” first transmitting a beacon frame. In this manner, the transmission of a beacon frame is not precisely coincident with the beacon transmission timing of the TSF function, but is slightly delayed due to the decrementing operation. On receiving the beacon frame from the station 300 in 200 milliseconds, the stations 10 and 200 both stop decrementing the respective random numbers.

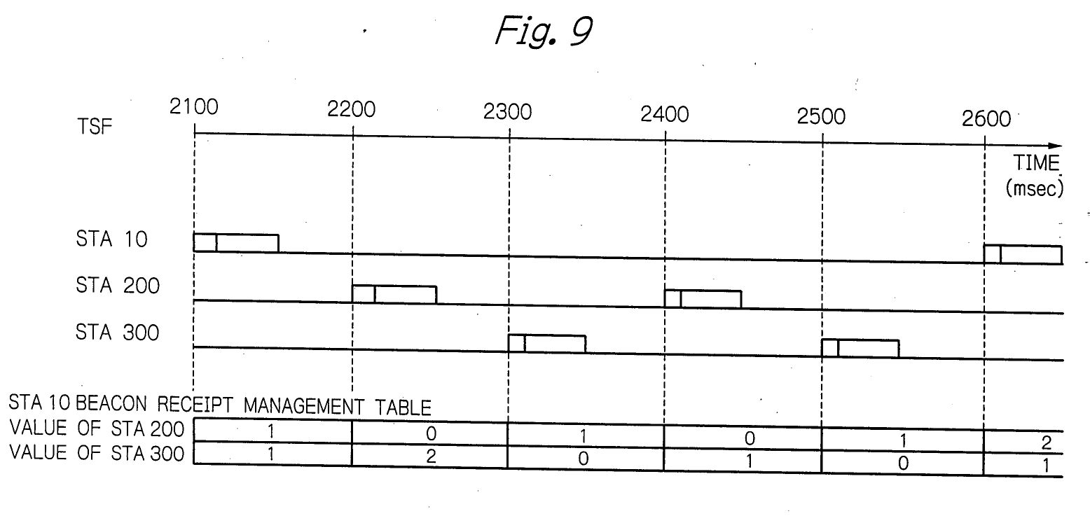

FIG. 9 demonstrates how the stations 10, 200 and 300 sequentially send beacon frames after the station 10 has sent a beacon frame in 2, 100 milliseconds. FIG. 9 additionally shows at its bottom the variation of values stored in the beacon receipt management table 54, which is controlled by the station 10 by way of example. The station 10 is shown as controlling the other stations 200 and 300 present in the area with the beacon receipt management table 54.

As shown in FIG. 9, the station 10, having sent a beacon frame first, increments values attached to the other stations 200 and 300 in the beacon receipt management table 54 to “1”. Subsequently, the station 200 sends a beacon frame in 2,200 milliseconds, so that the station 10 clears the value of the station 200 to “0” while incrementing the value of the station 300 to “2”. Further, when the station 300 sends a beacon frame in 2,300 milliseconds, the station 10 increments the value of the station 200 to “1” while clearing the value of the station 300 to “0”. In this manner, upon receiving a beacon frame, the station 10 clears the value attached to the source station having sent the beacon frame to “0” while incrementing the values of the other stations by 1 (one). Further, when the station 10 itself sends a beacon frame, it increments the values of all the other stations listed in the beacon receipt management table 54 by 1 (one), as stated previously.

The canceling decision circuit 50, FIG. 3, stores the beacon receipt management table 54 and updates the values stored in the table 54 in accordance with the rule described above. On the receipt of a decision signal 40 addressed to the station 10, the canceling decision circuit 50 determines whether or not the received frame 32 is a beacon frame and, if it is a beacon frame, whether or not the beacon frame is addressed to the station 10. If the answer of this decision is positive, the canceling decision circuit 50 determines whether or not the received frame 32 is normal in response to the normalcy decision signal 38 based on the FCS checking. Further, if the received frame 32 is normal, the canceling decision circuit 50 compares the addresses 56 of stations under control with the source address 36 to see if the source station having sent the beacon frame is under control. If the answer of this decision is positive, the canceling decision circuit 50 clears the value of the source station present in the beacon receipt management table 54 to “0” while incrementing the values of the other stations under control by “1”.

On the receipt of the own-station beacon transmission information 48 shown in FIGS. 1 and 3, the canceling decision circuit 50 recognizes the transmission of a beacon frame from the own station 10 and therefore increments the values of all stations under control listed in the beacon receipt management table 54 to “1”. Although the own-station beacon transmission information 48 may be output without regard to the timing of the received frame phase 20, as stated previously, the timing for processing a received beacon frame and the information 48 do not occur at the same time because frame interchange in a wireless LAN uses a half-duplex configuration that inhibits transmission and receipt from occurring at the same time.

The canceling decision circuit 50 sequentially updates the beacon receipt management table 54 in accordance with the rule stated above and can therefore see if any station has withdrawn from the IBSS area on the basis of the updated values of the table 54. This decision is based on the fact that when any station withdraws from the IBSS area and therefore stops sending beacon frames, the value of such a station stored in the beacon receipt management table 54 simply continues to increase.

The threshold value mentioned earlier is assigned to the beacon receipt management table 54 to determine whether or not any station present in the IBSS area has withdrawn from the area. In the illustrative embodiment, the threshold comprises an N multiple of the number of registered stations present in the IBSS area, as stated earlier, and is expressed as:
threshold value=number of stations×N (1)
where N is an integer greater than 1.

When, e.g. the expression (1) is satisfied, the canceling decision circuit 50 determines that a station reached the threshold value has withdrawn from the area and then delivers the cancellation command signal 60 and cancellation address 62 to the canceling processor 52 at the time 106 shown in FIG. 7, line (h). In response, the canceling processor 52 deletes the information relating to the above station stored in the storing device at the time 118 shown in FIG. 7, line (h). As shown in FIG. 3, the canceling processor 52 is outputting the addresses 56 of stations under control and the number information 58 to the canceling decision circuit 50.

More specifically, it is possible to switch, based on information indicative of the withdrawal of a station area lacking an RSNA ability expected to be standardized by IEEE 802.11i, the kind of code for a broadcast frame on an area basis or to switch, based on information indicative of the withdrawal of a station lacking an ERP ability standardized by IEEE 802.11g, a protection function from ON to OFF on an area basis. Stated another way, processing capability information obtained on a station basis is usable not only to execute processing based on a single station but also to execute network management and control or similar processing based on a single wireless LAN. The individual station is capable of executing management and control in accordance with the processing capability information of a station to withdraw from the area each time.

The station 10 has been shown and described as grasping the receipt condition of beacon frames by using the beacon receipt management table 54 for thereby grasping a station to withdraw from an IBSS or ad hoc network and canceling the registration of the station. Alternatively, the station 10 may be additionally provided with a function of canceling the registration without regard to the beacon receipt management table 54, i.e. on the receipt of a deauthentication frame. Further, while the station 10 determines a station to withdraw from an IBSS or ad hoc network in accordance with received beacon frame information and own-station beacon transmission information and then cancel the registration of such a station, the station 10 may neglect the own-station beacon transmission information, if desired.

To grasp the withdrawal of a station from an IBSS or ad hoc network, the station 10 may execute the following alternative procedure that updates the beacon receipt management table 54 on the basis of the interval between consecutive beacons that the station 10 sends. In the alternative procedure, the station 10 sets all the values of the beacon receipt management table 54 to “1” on transmitting a beacon frame. Subsequently, the station 10 resets the table value of the address from which it has received a beacon frame to “0” and then increments it by “l” on sending the next beacon frame. In this manner, the station 10 increments the table value by 1 every time it sends a beacon frame. The beacon receipt management table 54 does not allocate a particular storage capacity to each address to be registered, but allocates only a controlled storage capacity. In this condition, the station 10 continuously executes processing that does not set “1” until a count reaches, e.g. M (integer greater than 1) and resets an address from which a beacon frame has been received to “0”.

As soon as the station 10 sends a beacon frame M times, it references the beacon receipt management table 54. The canceling decision circuit 50 determines that a station whose table value is “1” has withdrawn from the area and then delivers the cancellation command signal 60 to the canceling processor 52 for thereby causing it to cancel the registration of the station. Thereafter, the station 10 sets the table values of all stations other than the canceled station to “1” and then repeats the above processing.

When the time at which the station 10 sends a beacon frame M consecutive times is used as a reference, as stated above, a single bit should only be allocated to each station on the beacon receipt management table 54. In addition, the station 10 can manage the receipt of beacon frames from a great number of stations simply by clearing the table value to “0” on the receipt of a beacon frame station by station.

As stated above, the station 10, joining an IBSS or ad hoc network, can analyze a beacon frame received from another or source station joining the network to thereby grasp and register the address of processing capability of the source station. Subsequently, the station 10 can confirm, in the event of transmission of a frame, the processing capability of the above station, or destination station, and selectively execute, e.g. encryption expected to be standardized by IEEE 802.11i or OFDM modulation already standardized by IEEE 802.11g. Further, the station 10 can selectively execute such processing in matching relation to the destination station.

Further, the station 10 can see the withdrawal of a station registered at the area by receiving a beacon frame from the station, updating the value of the station stored in the beacon receipt management table 54 and then comparing the updated value with the threshold value, and then delete the processing capability information of the station stored in a storing device. This is successful to efficiently use the limited station resources.

In summary, in the illustrative embodiment, the timing generator 12 included in the station 10 generates the timing signal 22 in accordance with the phase of a received frame. The decision circuitry 14 feeds the result of decision based on the timing signal 22 and received frame 32 to the registrar 16. In response, the registrar 16 determines the processing capability of a source station stored in the received frame and thus registers the processing capabilities and source addresses of all stations joining in a network. The canceller 18 cancels the address and processing capability information of a source station in accordance with the timing signal 22, normalcy decision signal 38, source address 36 and particular information based on the type of the received frame. It is therefore possible to grasp stations present in the area of an IBSS network even with a rule that conforms to IEEE 802.11, i.e. without using a scheme not conforming to IEEE 802.11.

In the registrar 16, the processing capability determining circuit 42 determines, in response to the decision signal 40 addressed to the station 10 and timing signal 22, whether or not the received frame 32 includes a field storing processing capability information and acquires, if the answer of the decision is positive, the processing capability information. The registering circuit 44 can therefore use a rule conforming to IEEE 802.11 when registering the source address 36 and processing capability information 46 in response to the normalcy decision signal 48. A frame that includes the field storing the processing capability information should preferably be implemented as a beacon frame or a probe response frame received.

In the canceller 18, the canceling decision circuit 50 receives the decision signal 40 output from the source address decision circuit 30, timing signal 22, source address 36, received frame 32 and particular information comprising the own-station beacon transmission information 48 and the addresses 56 and information 58 representative of the number of stations registered. By using such signals and particular information, the canceling decision circuit 50 determines whether or not the cumulative value counted in accordance with the counting condition of the individual station has reached the predetermined threshold to thereby determine whether or not to cancel the registration of a registered station, and outputs the cancellation command signal 60 if the answer of the above decision is positive. It follows that the canceling processor 52 is allowed to cancel the registration in accordance with the cancellation command signal 60 and source address 62 by using a rule customary with a wireless LAN, i.e. without resorting to a new rule.

The canceling decision circuit 50 uses a counting condition wherein, at least in accordance with whether or not a received beacon frame is sent from a station other than the own station 10 and whether or not the beacon transmission information is received. The canceling decision circuit 50 increments cumulative values stored on a source station basis if the answer of the former decision is positive or resets them if the answer of the latter decision is positive. This can be done with the threshold value which is an integral multiple of the number-of-station information 58 and greater than “1”. For this purpose, the canceling decision circuit 50 should preferably store the beacon receipt management table 54 listing the cumulative values of the individual stations.

Alternatively, the canceling decision circuit 50 may use a counting condition or rule that, by using the beacon transmission intervals of the own station 10 as a reference, sets a preselected value in all source stations when a beacon frame is sent from the station 10 and clears the values corresponding to addresses received the beacon frame to “0”. With this scheme, the canceling decision circuit 50 determines that a station whose value is identical with a preselected number of times of transmission of the beacon frame has withdrawn from the area, and again sets the preselected value in the other stations remaining in the area. This is successful to save the storage capacity by allocating only a single bit to each value stored in the beacon receipt management table 54.

Furthermore, the canceller 18 may be configured to grasp, on receiving a deauthentication frame as particular information, the address of a source station having sent the frame and the processing capability information of a received frame, thereby easily canceling the information without resorting to sophisticated processing.

The entire disclosure of Japanese patent application No. 2004-186601 filed on Jun. 24, 2004, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

1. A radio apparatus for use in a mobile station applicable to an IBSS (Independent Basic Service Set) network, comprising:
a timing generator for generating a timing signal in accordance with a phase of a received frame input to said radio apparatus;
decision circuitry for acquiring a source address of the received frame in response to the timing signal and the received frame, and determining a type of the received frame and whether or not the received frame is addressed to said radio apparatus and is correctly received;
a registrar for acquiring processing capability information representative of a processing capability of a source from the received frame in accordance with the timing signal, decision signals output from said decision circuitry and the source address, and registering the processing capability information and the source address; and
a canceller for determining a withdrawal from an area formed by the IBSS network in accordance with the timing signal, the decision signals output from said decision circuitry, the source address and particular information relating to the type of the received frame.

2. The apparatus in accordance with claim 1, wherein said registrar comprises:
an information acquiring circuit for determining, in response to the timing signal and the decision signal indicating that the received frame is addressed to said radio apparatus, whether or not the received frame includes a field for storing the processing capability information, and acquiring, if the received frame includes the field, the processing capability information; and
a registering circuit for registering the source address and the processing capability information fed in response to the decision signal indicating that the received frame is normal.

3. The apparatus in accordance with claim 1, wherein said canceller comprises:
a cancellation deciding circuit for using the decision signal indicating that the received frame is addressed to said radio apparatus, the timing signal, the source address, the received frame and the particular information, which comprises beacon transmission information send from said radio apparatus itself and addresses and a number of registered radio apparatuses, to determine whether or not a cumulative value counted on a source radio apparatus basis in accordance with a counting condition coincides with a predetermined threshold value to thereby determine whether or not to cancel a registration of a source radio apparatus, and generating, if the registration should be canceled, a registration cancellation command signal; and
a canceling circuit for canceling the registration in accordance with the registration cancellation command signal and the source address.

4. The apparatus in accordance with claim 2, wherein said canceller comprises:
a cancellation deciding circuit for using the decision signal indicating that the received frame is addressed to said radio apparatus, the timing signal, the source address, the received frame and the particular information, which comprises beacon transmission information send from said radio apparatus itself and addresses and a number of registered radio apparatuses, to determine whether or not a cumulative value counted on a source radio apparatus basis in accordance with a counting condition coincides with a predetermined threshold value to thereby determine whether or not to cancel a registration of a source radio apparatus, and generating, if the registration should be canceled, a registration cancellation command signal; and
a canceling circuit for canceling the registration in accordance with the registration cancellation command signal and the source address.

5. The radio apparatus in accordance with claim 3, wherein the counting condition comprises at least one of a requirement that the received frame is a beacon frame received from another radio apparatus and a requirement that the beacon transmission information is received,
said cancellation deciding circuit incrementing, in accordance with the counting condition, the cumulative value stored on a source radio apparatus basis if the received frame is a beacon frame received from the other radio apparatus or resets the cumulative value if the received frame is sent from said radio apparatus,
the threshold value comprising an integral multiple of the information representative of the number of registered radio apparatuses and greater than unity.

6. The apparatus in accordance with claim 4, wherein the counting condition comprises at least one of a requirement that the received frame is a beacon frame received from another radio apparatus and a requirement that the beacon transmission information is received,
said cancellation deciding circuit incrementing, in accordance with the counting condition, the cumulative value stored on a source radio apparatus basis if the received frame is a beacon frame received from the other radio apparatus or resets the cumulative value if the received frame is sent from said radio apparatus,
the threshold value comprising an integral multiple of the information representative of the number of registered radio apparatuses and greater than unity.

7. The apparatus in accordance with claim 3, wherein said cancellation deciding circuit comprises a storage for storing the cumulative value on a source radio apparatus basis.

8. The apparatus in accordance with claim 4, wherein said cancellation deciding circuit comprises a storage for storing the cumulative value on a source radio apparatus basis.

9. The apparatus in accordance with claim 3, wherein the counting condition comprises a rule that, by using beacon transmission intervals of said radio apparatus as a reference, sets a predetermined value in a storage on a source radio apparatus basis at a time when the received frame is a beacon frame sent from said radio apparatus, and resets to zero the predetermined value corresponding to an address associated with the beacon frame received,
said cancellation deciding circuit determining that a radio apparatus whose predetermined value is coincident with a predetermined number of times of transmission of the beacon frame has withdrawn from an area of the IBSS network, again setting the predetermined value for radio apparatuses remaining in the area, and repeating a decision based on the rule.

10. The apparatus in accordance with claim 4, wherein the counting condition comprises a rule that, by using beacon transmission intervals of said radio apparatus as a reference, sets a predetermined value in a storage on a source radio apparatus basis at a time when the received frame is a beacon frame sent from said radio apparatus, and resets to zero the predetermined value corresponding to an address associated with the beacon frame received,
said cancellation deciding circuit determining that a radio apparatus whose predetermined value is coincident with a predetermined number of times of transmission of the beacon frame has withdrawn from an area of the IBSS network, again setting the predetermined value for radio apparatuses remaining in the area, and repeating a decision based on the rule.

11. The apparatus in accordance with claim 1, wherein said canceller grasps, when supplied with a deauthentication frame as the particular information, an address corresponding to a source of the deauthentication frame and processing capability information of the received frame and cancels corresponding information.

12. The apparatus in accordance with claim 2, wherein said canceller grasps, when supplied with a deauthentication frame as the particular information, an address corresponding to a source of the deauthentication frame and processing capability information of the received frame and cancels corresponding information.
